(19) United States
(12) Patent Application Publication
(10) Pub. No.: US 2012/0233646 A1
(43) Pub. Date: Sep. 13, 2012

(54) SYNCHRONOUS MULTI-PLATFORM CONTENT CONSUMPTION

(76) Inventors: Straker J. Coniglio, Lexington, MA (US); Richard Gianattasio, Wellesley, MA (US)

(21) Appl. No.: 13/046,021

(22) Filed: Mar. 11, 2011

(51) Int. Cl. H04N 7/18

(52) U.S. Cl. 725/78

(57) ABSTRACT

The experience of a consumer of a primary video or audio program is enriched by providing secondary and time relevant content to a secondary device, such as a laptop computer, tablet, or smart phone. Transmissions of the primary video or audio are augmented by secondary data providing links to the secondary content. The secondary data also contains data identifying the corresponding primary program and the temporal location within the primary program at which the secondary content is to be offered. Upon receipt and display of a pre-produced primary program, a device driving the primary program output device, such as a set-top-box driving a television, transmits the secondary data over a local network to the secondary device, which displays links to the secondary data, and enables the consumer to request the corresponding secondary content for display on the secondary device. Indications of secondary content may also be sent to the primary program output device to inform the consumer of the availability of secondary content.

### BACKGROUND

Media consumers are increasingly using more than one modality concurrently to receive media information. Television viewers, for example, frequently use portable devices such as laptops, mobile phones, and tablet computers to search for and browse content that is complementary to what they are viewing on a home display or on a sports video display board. Consumer-directed searching and browsing typically causes the consumer to leave the experience that is controlled by the content provider. Not only does this preclude the content provider from programmatic control of the complementary material, which risks diluting the consumer experience, but the programmer also loses potential revenue from advertising, merchandising, and other commercial tie-ins.

Video program broadcasters and consumer electronics companies have attempted to meet the consumer appetite for complementary material by providing additional information on the television screen. However, this can clutter the display and leave a single person in control of the viewing experience of many. When broadcasters add interactive features using the television, they typically use the consumer's existing remote control as the input device. In addition to the screen clutter problem, this often gives rise to complexity in the remote, which can confuse viewers.

Some broadcasters provide static program information that is available over the Internet or via a set-top box or satellite link. Most commonly, such information includes a program guide, with the title, key producers or presenters, and a brief synopsis of the program.

One approach for providing complementary content in association with a primary program involves using an audio signal from the primary display device. This approach is ineffective in a noisy environment, such as in a public space, live sporting event or performing arts event because the audio signal may be drowned. Furthermore, this approach is not effective for primary programs that are audio only, such as music, as the audio synchronization signal could interfere with the primary program.

In another approach, a consumer synchronizes a secondary device with a primary program by pressing a “start” command at the beginning of the primary program. Though such manual synchronization starts the complementary content off in synchrony with the primary program, synchrony can quickly be lost if the primary program is paused or if advertisements of varying length are inserted into broadcast programs. Switching channels in mid-program also presents a synchronization problem in this scheme since the time reference at the program start is not available. In a variant of this scheme, a portable device uses information about the local time zone and a published start time of a program to synchronize itself with a primary program. As with the manual approach, synchronization is lost when continuous playback is interrupted, or channels are changed in mid-program.

### SUMMARY

The described methods and systems enable media consumers to receive secondary content on secondary devices such as laptops or smart phones, the secondary content being synchronized with a primary program that is being played on a main output device in the home or at a public venue. Individually tailored secondary content and non-linear content may be consumed by multiple consumers in real-time, with timing synchronized to the playing of the primary content on a main output device.

In general, in one aspect, methods, systems, and computer program products for providing secondary program content to a consumer of a corresponding primary video program involve: over a local network, receiving at a secondary device data specifying secondary program content, wherein the local network is connected to the secondary device and to a set-top box connected to a primary display for displaying the primary video program, and wherein the data specifying secondary program content is transmitted over the local network by the set-top box; displaying on the secondary device an indication of the specified secondary program content substantially synchronously with a display on the primary display of a portion of the primary video program associated with the specified secondary program content; enabling the consumer to select on the secondary device the indication of the secondary content, thereby causing the secondary device to request the secondary program content; receiving the secondary program content at the secondary device; and displaying the secondary program content on the secondary device.

Various embodiments include one or more of the following features. The data specifying secondary program content includes a link to the specified secondary program content. The data specifying secondary program content further includes at least one of a program identifier that identifies the primary video program and a time code corresponding to a temporal location of the portion of the primary video program associated with the specified secondary program content. The secondary device only displays the indication of the secondary program content if the program identifier corresponds to a program selected for viewing on the primary display by the consumer. The secondary device is a mobile device connected to the local network via a wireless connection. The secondary device is a smart phone or a tablet computer. The indication of the secondary program content includes at least one of text and a graphic element with an associated URL, and the consumer selects the secondary program content by selecting the text and/or graphic element. The set-top box receives the data specifying the secondary program content and, in response to receiving the data specifying the secondary program content, sends to the primary display an indication of the availability of secondary program content. The data includes information indicating a type of the secondary program content, and the indication of the availability of secondary program content is displayed on the primary display using a visual attribute determined by the type. The primary video program is received by the set-top box as an IP packet stream, the data specifying secondary program content is received as secondary content packets embedded within the IP packet stream, and the set-top box extracts the data specifying secondary program content from the secondary content packets and transmits the data specifying secondary program content over the local network. The primary video program is received by the set-top box as a video signal, the data specifying secondary program content is encoded as ancillary data within video signal, and the set-top box extracts the data specifying secondary program content and transmits the data specifying secondary program content over the local network. The primary video program is received by the set-top box from a DVR connected to the set-top box. The received secondary program content includes at least one of text, graphics, time-based media, and interactive content. The received secondary program content includes background information relating to the portion of the primary video program associated with the secondary program content. The secondary device further receives and displays advertising information relating to the portion of the primary video program associated with the secondary program content. The consumer selects the primary video program for viewing at an arbitrary temporal location within the primary video program, and, in response the secondary device displays an indication of secondary program content associated with a temporal location substantially corresponding to the arbitrary temporal location. The primary video program is one of a live program and a pre-produced program.

In general, in another aspect, providing secondary program content to a consumer of a corresponding primary time-based video content includes: using a secondary device to receive over a local network data specifying the secondary program content, wherein the local network is connected to the secondary device and to a companion unit connected to a set-top box and to a primary display for displaying the primary time-based video content, and wherein the data specifying the secondary program content is transmitted over the local network by the companion unit; displaying on the secondary device an indication of the secondary program content substantially synchronously with displaying a portion of the primary time-based video content associated with the secondary program content; enabling a user of the secondary device to select the indication of the secondary content, thereby causing the secondary device to request the secondary program content; receiving the secondary program content at the secondary device; and displaying the secondary program content on the secondary device. In one embodiment, the set-top-box receives the data specifying the secondary program content and forwards the data specifying the secondary program content to the companion unit.

In general, in a further aspect, a computer program product includes: storage including instructions for a processor to execute, such that when the processor executes the instructions, a process for providing secondary program content to a consumer of a corresponding primary time-based program is performed, the process comprising: over a local network, receiving at a secondary device data specifying secondary program content, wherein the local network is connected to the secondary device and to a set-top box connected to a primary display for displaying the primary video program, and wherein the data specifying secondary program content is transmitted over the local network by the set-top box; displaying on the secondary device an indication of the specified secondary program content substantially synchronously with display on the primary display of a portion of the primary video program associated with the specified secondary program content; enabling the consumer to select on the secondary device the indication of the secondary content, thereby causing the secondary device to request the secondary program content; receiving the secondary program content at the secondary device; and displaying the secondary program content on the secondary device.

In yet another aspect, a portable device includes a processor for executing instructions; a network input connected to the processor; a user input device connected to the processor; a display connected to the processor; a memory connected to the processor, the memory including instructions which, when executed by the processor, cause the portable device to implement a process for providing secondary program content to a consumer of a corresponding primary time-based program, the process comprising: receiving over a local network via the network input data specifying the secondary program content, wherein the local network is connected to the portable device and to a set-top box connected to a primary display for displaying the primary time-based program, and wherein the data specifying the secondary program content is transmitted over the local network by the set-top box; displaying on the display an indication of the secondary program content substantially synchronously with a display on the primary display of a portion of the primary time-based program associated with the secondary program content; enabling the consumer to select on the portable device the indication of the secondary content using the user input device, thereby causing the portable device to request the secondary program content via the local network; receiving via the network input the secondary program content; and displaying the secondary program content on the display.

### BRIEF DESCRIPTION OF THE DRAWINGS

FIG. 1 is high level flow diagram of a method of synchronously providing secondary program content.

FIG. 2 is a high level block diagram of the components of a system for synchronously providing secondary program content.

FIG. 3 is a diagrammatic representation of the display of a video program on a primary video display with indications of the availability of secondary program content.

FIG. 4 is an illustration of a display of a secondary device for synchronous consumption of secondary program content.

### DETAILED DESCRIPTION

The systems and methods of media consumption described herein enable secondary information to be provided in a manner that is temporally synchronized with the playback of a corresponding primary program. The secondary program content is received and consumed on a secondary device, such as commercially available mobile device connected to a local area network either wirelessly or via a fixed connection. Such devices include a laptop computer, a tablet computer, or a smart phone.

We now describe embodiments in which the primary program is a video program. Embodiments in which the primary program is an audio only program are described below.

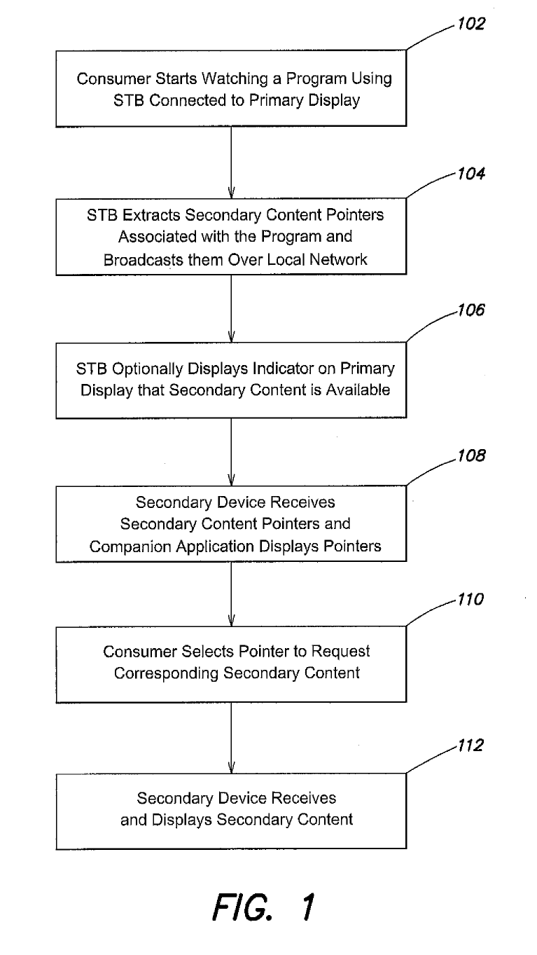

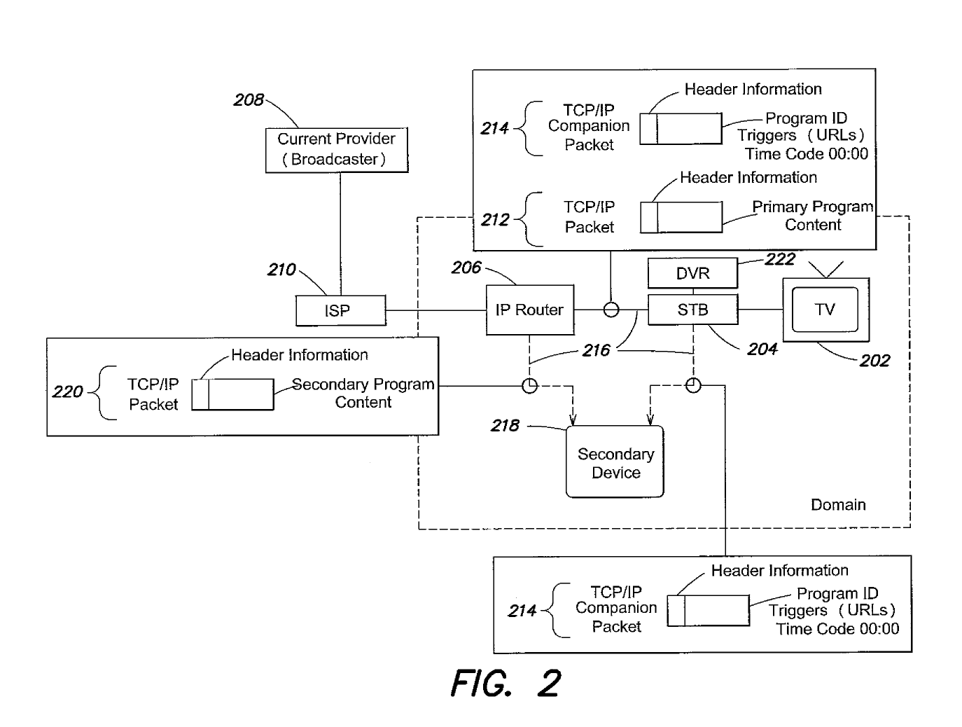

FIG. 1 is a high level flow diagram showing the main steps involved. A high level block diagram of a corresponding system for implementing the method is shown in FIG. 2. The process is initiated when a consumer starts viewing a video program on primary display 202, such as by selecting a channel for a live broadcast, or pressing “play” on a remote control for a pre-recorded broadcast (step 102). The primary display receives its video signal from set-top box (STB) 204. As used herein, STB 204 represents a video streaming receiver, cable box, a digital tuner, DVR, over-the-top (OTT), or other device that receives an analog or digital data stream from the Internet, or via cable, satellite, or over-the-air broadcasts (not shown), and converts the received stream into video for display on the primary display. The STB may be embedded within primary shared display 202, such as, for example, an internet-enabled television set. If the consumer requests a live video broadcast, the STB requests the corresponding live content. In the embodiment illustrated in FIG. 2, the video program is broadcast using IPTV, in which the content is received by the STB as a stream of IP packets. The packets are received via local IP router (e.g., a home router) 206, which in turn receives the media packet stream from remote content provider 208 via internet service provider (ISP) 210.

In addition to packets containing the primary program content (212), the media stream includes companion packets (214) which are introduced into the stream by the content provider in order to signal the availability of secondary content and direct consumers to such content. STB 204 identifies the companion packets, and extracts their content, which includes a pointer, link, or other indicator of the available secondary content. The companion packets may also include a time code that specifies the temporal position within the primary program with which the secondary content is associated and a program identifier that uniquely specifies the program being streamed. The link may be a URL, or other information that specifies where the secondary content is located.

The producer of the program inserts companion packets at intervals within the primary media stream at which the secondary content first becomes relevant to the corresponding location within the primary program. For pre-produced content, the companion packets are inserted at production time. For live content, the producer prepares content for the packets in advance, generating a pre-determined shot list or a pick list of historic content, and then finalizes and inserts the companion packets upon the occurrence of specific events. In addition, live content producers may interface to data feeds to provide real-time information. This may be implemented using a content management system that receives a live data feed, and formats the data appropriately for the secondary device at a linkable location. The STB is able to determine the temporal locations in the primary program that are associated with the secondary program content implicitly from the location of the companion packet within the stream, or explicitly from the time code carried by the companion packet. The time interval between the insertion of successive companion packets ranges from a few seconds to several minutes or more, depending on the nature of the primary program, the quantity and nature of the available secondary material, and the desired upper limit on syncing delay for a viewer who switches to a program midway. In order to enable rapid synching at any point within the primary program, repeated companion packets are sent at regular intervals, even if no new secondary content is available. With a repeat interval in the range of a few seconds, the addition of companion packets is not sufficient to significantly impact the bandwidth required to stream the primary program.

In various embodiments, the primary STB and/or the primary display receives broadcasts via cable, satellite, or over the air. Most such broadcasts transmit video as a video signal rather than as the IP stream associated with IPTV. For video signal broadcasts, the secondary content is encoded in the ancillary data field, and is extracted by the STB using techniques similar to those used to extract closed caption or other information from video signals. The STB identifies the presence of secondary information via a specific type identifier in the ancillary data. For analog video signals, the ancillary data is transmitted in the vertical blanking interval. For digital transmissions, the data is associated with a specific DID/SDID pair that identifies it as synchronous secondary data. The following is a sample XML representation of secondary vertical ancillary data:

<SyncTV>
<PID> 1001</PID>
<PTC>00:00:05:32</PTC>
<PlinkPath>http://www.nbc.com/synctv/content</PlinkContent>
<Plink1>
<Title>Stats</Title>
<link>sports/football/2011/game1/stats.html</link></Plink1>
<Plink2>
<Title>Sponsor</Title>
<link>ads/sponsor/sports/content.html</link>
</Plink2>
<Plink3>
<Title>Event Timeline</Title>
<link>/sports/football/2011/game1/TOC.html</link>
</Plink3>
<Plink4>
<Title>Promo</Title>
/promos/primetime/content.html</Plink4>
</SyncTV>
Where:
PID = Program ID
PTC = Program TimeCode
PlinkPath = Primary path to secondary content
Plink x = title, truncated path to secondary content using primary path, and other content that will populate the frames.

The number of different secondary content elements (Plink events) is limited only by the usable display area on the secondary device.

Once the secondary content has been extracted, STB 204 broadcasts the secondary information over local network 216, using Wi-Fi, Bluetooth, or other wireless networking technology. In larger venues such as arenas or stadiums, the secondary signal can be broadcast within the premises using wireless networking technology within the local area.

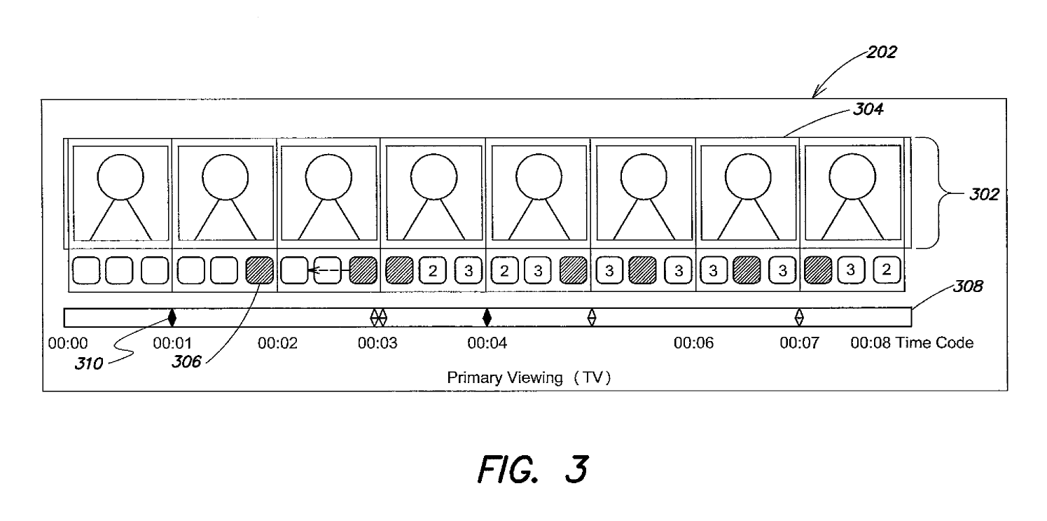

In addition, STB 204 also sends an indication of the availability of secondary information to the primary display, which optionally displays an indication to the consumer that secondary content is available (step 106). FIG. 3 illustrates an example of such an indication. Primary, pre-produced program 302 is displayed as a series of frames 304 on primary display 202. An on-screen indication, such as graphic element 306, is displayed in the frame at or near the temporal location within the program at which secondary content becomes available for the secondary device. The graphic remains on the screen for a predetermined period of time or until other graphics are available to take its place.

Companion packets may include additional information identifying a type of the secondary content, and the on-screen indication may display the type. For example, in FIG. 3, three types of secondary content are indicated by the graphic elements labeled 1, 2, or 3. In addition, timeline representation 308 of the temporal sequencing of the secondary content may be displayed on the primary viewing device, with the location of secondary content triggers, i.e., companion packets, shown using a visual indication, such as marker 310, at the corresponding temporal location along the timeline. Examples of secondary content types include, but are not limited to: background information on program participants, such as biographies of actors or statistics on sports players; links to previous episodes or relevant events; commercial sites offering soundtracks, key items shown in the primary program, memorabilia, or merchandise; interactive games relating to the characters or themes of the primary program; and links to an abridged video featuring primary program highlights.

In alternative embodiments, the STB is an unmodified commercial device, and identification, extraction, and broadcasting of the data specifying secondary content, whether received as companion packets (IPTV) or as ancillary data within a digital or analog video signal, is performed by a separate companion unit. The companion unit is located in the signal path between the STB and the primary display, and includes a secondary data decoder which extracts the data specifying secondary content from the ancillary data within the video signal, and broadcasts the data over the local network, such as a home Wi-Fi network, or via Bluetooth. The secondary data decoder acts in a similar fashion to closed caption decoders, but extracts ancillary data associated with a secondary data identifier rather than a closed caption identifier. As described above in connection with integral STB 204, in addition to broadcasting indications of secondary content availability over the local network, the companion unit may send an indication of the availability of secondary information to the primary display for displaying to the consumer (as illustrated in FIG. 3) that secondary content is available.

In live video venues, such as at sporting events or musical performances, the primary video content may be captured in real time and pass through a live video mixing and production system on its way to the primary display, effectively eliminating the STB. In such settings, synchronized secondary content may be created using a separate secondary content creation system directly linked to a companion unit. As previously described, when secondary content is available, an indication is sent to the primary display to alert viewers as to the availability of secondary content.

Secondary device 218, which is also connected to local network 216, receives the secondary content information transmitted from the STB. In various embodiments, the secondary device is a mobile device, such as a laptop, tablet, smart phone, or other personal portable device. In a typical scenario, each consumer has control of one such secondary device.

A companion application running on the secondary device manages the receipt of data specifying secondary program content, the display of indications of the specified secondary content on the secondary device display, user requests for the secondary program content, and other operations regarding the secondary content. Upon receiving data specifying available secondary content, the companion application detects the receipt of the data, and displays an indication of the specified secondary content within a scrolling list (step 108). The companion application determines the layout and appearance of the secondary content on the secondary device. In some embodiments, the content producers may include information determining how indications of secondary program content are to be displayed, such as font, color, positioning, etc. In the described embodiment, the secondary content information is a URL pointing to a web site containing the secondary content. In other embodiments, secondary content information is represented as XML, which can include reference to graphic elements, photos, or other actively linked content.

Whenever the consumer wishes to be made aware of and receive secondary content, the companion application is actively (or passively) running on the secondary device in the foreground (or the background). The companion application interprets, and displays the indications of the secondary content received in the companion packets. If the application is running in the background, it collects the packets to maintain the current content in the event the user brings the application to the foreground. As the packets contain only links or other pointers specifying a location of the secondary material, the secondary content to be displayed on the secondary device can be changed by the content producer allowing them to make updates to the content, as well as to graphical elements, layout, and content prioritization, without making any changes to the underlying video content. As the secondary device receives the packets, the application has specific panels within the layout in which to display the pointer (‘Plink’) data. Each Plink data relates to a panel on the companion application that has been predetermined by the content publisher. As the user navigates to different parts of the application, the layout of the Plink data can change, or the publisher can choose to populate panels or pages without the use of Plink data. For example, when navigating to an e-commerce Plink—the user may surf around within that frame to non-Plinked data. However, the application will still be collecting and displaying any Plink data on panels within the page that are driven by Plink data.

More than one primary program may be simultaneously received within the LAN, serving multiple primary display devices. For each received program, the router directs the primary program stream as well as the embedded companion packets to the requesting STB and primary display device for display. A secondary device on the LAN receives companion packets being broadcast from each of the active STBs that is receiving a primary program on the LAN. The companion application enables each consumer to select the program for which they wish to view secondary content on their device. Accordingly, the application running on the secondary device only displays links relating to the selected program, using the program identifier included in the companion packets to distinguish the primary program to which each received packet belongs. In some embodiments, each STB (and its associated display device) is given a unique identifier which is associated with each of the broadcast companion packets; the companion application enables the consumer to specify the identifier of the STB/primary display being watched. This enables the companion application to follow the program the consumer is watching, even if the channel is changed, without the need for additional input from the consumer.

If the consumer wishes to be made aware of secondary content associated with other primary programs being received, or with other recently consumed programs (e.g., before switching channels), the application displays the secondary content for each program in a specific portion of the display, or otherwise differentiates between the various secondary content streams, e.g., by color or font.

Multiple secondary devices may be connected to the local network, each one belonging to a different media consumer watching the primary display. Each consumer uses their secondary device to choose the particular secondary content they wish to view. If the program being displayed is changed, the program ID associated with the secondary program content also changes. The companion application enables each consumer to determine whether their device is to continue to display pointers to secondary content associated with the program being watched prior to the program change, or whether to refresh the display to show only secondary content associated with the new primary program.

As soon as the secondary device displays the received links to secondary content, the consumer may request the content by clicking on, or otherwise using an input device connected to the secondary device to select a displayed indication of secondary program content (such as a text link, an image, or a graphic element) on the secondary device (step 110). The secondary device then sends out a request for the secondary content over the local network and, via the router, over the Internet. A remote server responds, sending the content over the Internet to the router, which in turn routes secondary content packets 220 to the secondary device for display (step 112). The secondary content may include, but is not limited to static or dynamic content in the form of images, videos, interactive content, games, in-app commerce, advertising, and text.

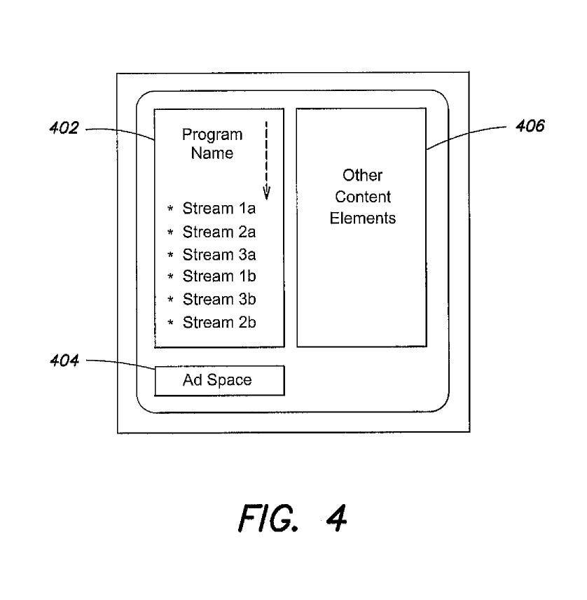

An example of a suitable display layout on secondary device 218 is shown in FIG. 4. A portion 402 of the screen displays the program name together with an associated logo or graphic/picture, and a scrolling list of indications, such as links, of the secondary content. The display is updated based on receipt of the companion packets and on the progression of the primary content through the program timeline. In addition to secondary program content, screen portion 404 is reserved for displaying advertising material. Additional screen region 406 displays other content elements, including images, text, or interactive elements.

The user can dive in on a particular piece of content that takes over the entire screen of the secondary device, and gives content creators the greatest scope. However, the companion application continues to collect data specifying secondary content, such as the URLs, in sync with the main program so that when the user navigates backwards to the home display, all the additional content updates missed during a deep dive of a particular item are available.

Such deep dives may include e-commerce opportunities, for example to allow a viewer to purchase an item featured in the primary program. In another example, a viewer can obtain further information on a topic relating to the primary program, or about an actor in a film.

In another scenario, the primary video program requested by the consumer is not a live broadcast, but is played back from an attached video source, such digital video recorder (DVR) 222. In this scenario, the primary and secondary content is received by STB 204 from the DVR in the same form as it would have been received in a live broadcast. Thus a recorded IPTV program is retrieved in its original form, complete with secondary packets embedded within the primary program packet stream. For a program received via cable, satellite, or over the air as a video signal, the recorded video signal is retrieved from the DVR, and the STB extracts and broadcasts the secondary content information in the manner described above in connection with a live broadcast. Thus no matter whether the primary program is being viewed live or prerecorded, the secondary content information is transmitted to local secondary devices in synchrony with the playback of the program currently being viewed. This synchronization is preserved even when playback is paused, or the program is backed up or advanced, or if the viewer starts part way into the program.

We now describe some exemplary usage scenarios of synchronous consumption of secondary program content.

### Example 1

### Nature Program on Television

In the first example, a viewer at home begins watching an episode of a program on sharks featuring hammerhead sharks. As the program begins, an icon appears on the lower third of the television indicating that this program includes enhanced content that may be viewed on a personal mobile device. The viewer accesses an application on a tablet computer, and upon launch, the application synchronizes itself to the television and begins displaying content that is synchronized with the shark program. Three minutes into the program, the program cuts to an interview with a shark expert. The tablet displays a picture of the expert obtained via a link in a companion packet using, for example, the following XML instructions:

<SyncTV>
<PID> 1001</PID>
<PTC>00:03:02:21</PTC>
<PlinkPath>http://www.sharkloverstelevision.com/synctv/
content</PlinkContent>
<Plink1>
<Title>Title</Title>
<link>hammerheadweek/hammerhead/titlegraphic.jpg</link></Plink1>
<Plink2>
<Title>Dr. Smith Image</Title>
<link> hammerheadweek/hammerhead/evansmith.jpg </link>
</Plink2>
<Plink3>
<Title>Dr. Smith Bio<Title>
<link hammerheadweek/hammerhead/smithbio.html</link>
</Plink3>
<Plink4>
<Title>TOC</Title>
hammerheadweek/hammerhead/TOC.html</Plink4>
</SyncTV>

In the above, Plink 1 provides the path to display a banner graphic, Plink2 provides the path to display an image of the shark expert, Plink3 provides the path to display the shark expert's bio, and Plink 4 provides the path to display the running table of contents. The secondary content is served to the device via these link paths, which are contained in the XML structure.

The text invites the viewer to touch the image to learn about the expert. The viewer responds, and the display changes to provide a bio and additional background information on the expert. Once finished with the bio, the viewer returns to a home screen. Six minutes into the program, the viewer sees a scuba diver check his dive computer, and wishes to learn about dive computers and the specific model being worn by the diver. At the same time, the secondary device provides a link to further details on what people in the program are wearing, and uses further links to obtain detailed information about the specific dive computer model featured. At twenty minutes into the program, there is footage of cage diving with sharks. The viewer is interested in learning more about this, and is provided with links that enable browsing among clips from other nature program episodes that contain cage dives. The user bookmarks an episode to watch later in its entirety on the primary display.

### Example 2

### Live Sporting Event—Figure Skating

As the event kicks off in a packed venue, a JumboTron display indicates that the event supports synchronized secondary content. Members of the audience access an application on their smart phones, which synchronizes them with the in-stadium display through the venue's wireless LAN. A particular audience member has a poor seat, and is not able to see which skater just pulled off a triple axle. She looks at her phone where event statistics are updated in real time, and clicks on the most recent jump, which responds by providing a list of jumps in the skater's program. She then clicks on the skater in question to obtain the video replay for a specific jump. If the JumboTron fails to show a good view of the jump, the fan accesses an instant replay function, and is able to see the jump from multiple angles.

The audience member may also wish to see a history of the skater's scores from previous events or a biography. A link to this content is displayed during the routine for each skater on the secondary device. Next, the JumboTron shows an advertisement for memorabilia related to the skater. The phone application also shows the advertisement, and enables the fan to place an order and pay for purchases, and to enter her seat number. The item is delivered to the viewer without her leaving her seat. The JumboTron posts a trivia question, and the viewer answers within the application on her smart phone. The aggregated results are displayed on the JumboTron.

### Example 3

### Televised Sporting Event

During the pre-game show, two friends launch the synchronized content application on their portable devices, which synchronize with the primary program. One friend plays Fantasy Football, an interactive virtual competition, and also uses her portable device to track player results in real time. The other friend uses the application on her personal portable device to probe for deeper pre-game analysis. Each person is able to choose from a list of widgets that can be displayed within the application, some of which may be synchronized with the main display, and some which may not. The synchronized items are updated in real time from various remote sources.

The methods and systems described herein may also be used in connection with primary audio-only programs, both live and pre-recorded. For audio, the system configuration is similar to that illustrated in FIG. 2, but with the set-top box and the television replaced by a digital audio processing and output system. When companion packets indicating the presence of secondary content are received at the local network and audio processing unit, the unit extracts and broadcasts the indications of secondary content over the local network. Secondary devices on the network receive these broadcasts, and synchronous content (i.e., companion) applications on connected secondary devices display links or other indications of the availability of secondary content, which can then be requested by the listener, in a similar fashion to that described above in connection with secondary content associated with a video program.

We now describe some exemplary use cases for consuming synchronous secondary content in association with an audio-only primary program.

Classical music generally adheres to a particular musical form (e.g., sonata, fugue), and may have distinctive themes and subjects. Synchronous descriptions of the various parts of a musical form in real time as a piece is being played may enhance a listener's musical appreciation. The synchronous nature of the secondary material is especially useful to pinpoint particular musical elements while they are playing.

The secondary device may display the musical score synchronously with play back. For works with large numbers of musical parts, such as in a symphony, a listener may select only a portion of the score for viewing, e.g., the strings, or the woodwind.

Secondary content relating to an audio program may also include information about the composer or performing artists. Such material may be synchronous for performers with changing roles during a performance, such as when a musician plays a solo in a jazz concert.

Additionally, secondary material may include a real time video of a live concert peroformance of the primary musical program, or a video of a past performance when the primary program is a recording. Further secondary material may include suggestions for listening to other music of a similar genre to the primary music program, or music that is favored by listeners of the primary program.

Systems and method for providing secondary program content as described herein may be implemented as a computer program using a general-purpose computer system. Such a computer system may be an integrated portable system, which typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), touch screens, plasma displays, OLED displays, video projection systems and other video output devices, loudspeakers and other audio output devices; printers, devices for communicating over a low or high bandwidth network, including network interface devices, cable modems, and storage devices including solid state devices such as flash memory, or magnetic media such as disk or tape. One or more input devices may be connected to the computer system. Example input devices include, but are not limited to, a touch screen, keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connection may be via a fixed connection, such as via an Ethernet network, or via a wireless connection, such as Wi-Fi or Bluetooth. The connected network may transfer to and from the computer system program instructions for execution on the computer, audio and video media data, metadata, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on a storage medium to be processed by the application program. The invention is not limited to a particular memory system. Time-based media may be stored on and input from magnetic or optical discs, which may include an array of local or network attached discs, or via local or wide area networks via network interfaces.

A system such as described herein may be implemented in software or hardware or firmware, or a combination of the three. The various elements of the system, either individually or in combination may be implemented as one or more computer program products in which computer program instructions are stored on computer readable storage for execution by a computer, or transferred to a computer system via a connected local area or wide area network. As used herein, such computer readable storage is non-transitory, and is to be distinguished from transitory media, such as modulated electromagnetic radiation. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method of providing secondary program content to a consumer of a corresponding primary video program, the method comprising:
over a local network, receiving at a secondary device data specifying secondary program content, wherein the local network is connected to the secondary device and to a set-top box connected to a primary display for displaying the primary video program, and wherein the data specifying secondary program content is transmitted over the local network by the set-top box;
displaying on the secondary device an indication of the specified secondary program content substantially synchronously with a display on the primary display of a portion of the primary video program associated with the specified secondary program content;
enabling the consumer to select on the secondary device the indication of the secondary content, thereby causing the secondary device to request the secondary program content;
receiving the secondary program content at the secondary device; and
displaying the secondary program content on the secondary device.

2. The method of claim 1, wherein the data specifying secondary program content includes a link to the specified secondary program content.

3. The method of claim 2, wherein the data specifying secondary program content further includes at least one of a program identifier that identifies the primary video program and a time code corresponding to a temporal location of the portion of the primary video program associated with the specified secondary program content.

4. The method of claim 2, wherein the data specifying secondary program content further includes a program identifier that identifies the primary video program, and wherein the secondary device only displays the indication of the secondary program content if the program identifier corresponds to a program selected for viewing on the primary display by the consumer.

5. The method of claim 1, wherein the secondary device is a mobile device connected to the local network via a wireless connection.

6. The method of claim 5, wherein the secondary device is one of a smart phone and a tablet computer.

7. The method of claim 1, wherein the indication of the secondary program content includes at least one of text and a graphic element with an associated URL, and wherein the consumer selects the secondary program content by selecting the at least one of a text and a graphic element.

8. The method of claim 1, wherein the set-top box receives the data specifying the secondary program content and, in response to receiving the data specifying the secondary program content, sends to the primary display an indication of the availability of secondary program content.

9. The method of claim 8, wherein the indication of secondary program content includes information indicating a type of the secondary program content, and wherein the indication of the availability of secondary program content is displayed on the primary display using a visual attribute determined by the type.

10. The method of claim 1, wherein the primary video program is received by the set-top box as an IP packet stream, and wherein the data specifying secondary program content is received as secondary content packets embedded within the IP packet stream, and wherein the set-top box extracts the data specifying secondary program content from the secondary content packets and transmits the data specifying secondary program content over the local network.

11. The method of claim 1, wherein the primary video program is received by the set-top box as a video signal, and wherein the data specifying secondary program content is encoded as ancillary data within video signal, and wherein the set-top box extracts the data specifying secondary program content and transmits the data specifying secondary program content over the local network.

12. The method of claim 1, wherein the primary video program is received by the set-top box from a DVR connected to the set-top box.

13. The method of claim 1, wherein the received secondary program content includes at least one of text, graphics, time-based media, and interactive content.

14. The method of claim 1, wherein the received secondary program content includes background information relating to the portion of the primary video program associated with the secondary program content.

15. The method of claim 1, further comprising:
over the local network, receiving at the secondary device advertising information relating to the portion of the primary video program associated with the secondary program content; and
displaying the advertising information on the secondary device.

16. The method of claim 1, wherein the consumer selects the primary video program for viewing at an arbitrary temporal location within the primary video program, and wherein, in response the consumer selection, the secondary device displays an indication of secondary program content associated with a temporal location substantially corresponding to the arbitrary temporal location.

17. The method of claim 1, wherein the primary video program is a live program.

18. A method of providing secondary program content to a consumer of a corresponding primary time-based video content, the method comprising;
using a secondary device to receive over a local network data specifying the secondary program content, wherein the local network is connected to the secondary device and to a companion unit, wherein the companion unit is connected to a set-top box and to a primary display for displaying the primary time-based video content, and wherein the data specifying the secondary program content is transmitted over the local network by the companion unit;
displaying on the secondary device an indication of the secondary program content substantially synchronously with displaying a portion of the primary time-based video content associated with the secondary program content;
enabling a user of the secondary device to select the indication of the secondary content, thereby causing the secondary device to request the secondary program content;
receiving the secondary program content at the secondary device; and
displaying the secondary program content on the secondary device.

19. The method of claim 18, wherein the set-top-box receives the data specifying the secondary program content and forwards the data specifying the secondary program content to the companion unit.

20. A computer program product comprising:
storage including instructions for a processor to execute, such that when the processor executes the instructions, a process for providing secondary program content to a consumer of a corresponding primary time-based program is performed, the process comprising:
over a local network, receiving at a secondary device data specifying secondary program content, wherein the local network is connected to the secondary device and to a set-top box connected to a primary display for displaying the primary video program, and wherein the data specifying secondary program content is transmitted over the local network by the set-top box;
displaying on the secondary device an indication of the specified secondary program content substantially synchronously with display on the primary display of a portion of the primary video program associated with the specified secondary program content;
enabling the consumer to select on the secondary device the indication of the secondary content, thereby causing the secondary device to request the secondary program content;
receiving the secondary program content at the secondary device; and
displaying the secondary program content on the secondary device.

21. A portable device comprising:
a processor for executing instructions;
a network input connected to the processor;
a user input device connected to the processor;
a display connected to the processor;
a memory connected to the processor, the memory including instructions which, when executed by the processor, cause the portable device to implement a process for providing secondary program content to a consumer of a corresponding primary time-based program, the process comprising:
receiving over a local network via the network input data specifying the secondary program content, wherein the local network is connected to the portable device and to a set-top box connected to a primary display for displaying the primary time-based program, and wherein the data specifying the secondary program content is transmitted over the local network by the set-top box;
displaying on the display an indication of the secondary program content substantially synchronously with a display on the primary display of a portion of the primary time-based program associated with the secondary program content;
enabling the consumer to select on the portable device the indication of the secondary content using the user input device, thereby causing the portable device to request the secondary program content via the local network;
receiving via the network input the secondary program content; and
displaying the secondary program content on the display.
